(19) United States
(12) Patent Application Publication
(10) Pub. No.: US 2005/0207698 A1
(43) Pub. Date: Sep. 22, 2005

(54) Signal transmission system

(76) Inventor: Thomas Weiser, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/511,799

(22) PCT Filed: Apr. 8, 2003
(86) PCT No.: PCT/IB03/01432

§ 371 Date: Oct. 19, 2004

(30) Foreign Application Priority Data
Apr. 23, 2002 (EP) 012100400.7

(51) Int. Cl. G02B 6/26

(52) U.S. Cl. 385/31; 385/15

(57) ABSTRACT

In a signal transmission system (1), a signal source device (2) that is arranged to generate a transmission signal, and a signal sink device (4) that is arranged to process the transmission signal, the two having, provided between them, transmission means that are arranged for the transmission of a signal representing the transmission signal, are coupled for the transmission of signals, the signal source device (2) being arranged to emit an optical signal (S) that represents the transmission signal generated, the signal sink device (4) being arranged to receive the optical signal (S) emittable by the signal source device (2), and the transmission means being formed by light-guiding means (7) that are able to be coupled optically to the signal source device (2) and the signal sink device (4) and that are arranged to transmit the optical signal (S).

The invention relates to a signal transmission system having a signal source device that is arranged to generate a transmission signal, having a signal sink device that is arranged to process the transmission signal, and having transmission means that are provided between the signal source device and the signal sink device, that can be coupled to the signal source device and the signal sink device for the transmission of signals, and that are arranged to transmit a signal representing the transmission signal from the signal source device to the signal sink device.

The invention further relates to a garment for a signal transmission system.

The invention further relates to a signal transmission method for transmitting a transmission signal from a signal source device to a signal sink device, wherein the transmission signal is generated by means of the signal source device and processed by means of the signal sink device, which method has the steps specified below, namely, transmission of a signal representing the transmission signal from the signal source device to the signal sink device by means of transmission means that are provided between the signal source device and the signal sink device and that are coupled to the signal source device and the signal sink device for the transmission of signals.

A signal transmission system of the kind described in the first paragraph above and a signal transmission method of the kind described in the third paragraph above have been developed by the applicant, the signal transmission system having been put on the market as a portable compact-disc player system having the type code AZT9240, which means that both the signal transmission system and the signal transmission method are known.

As the transmission means between a signal source device that is formed by a compact-disc playing device and a signal sink device that is formed by headphones that can be worn on the head of a user, the known signal transmission system has a cable that is coupled to the signal source device by a plug-in connection and to the signal sink device by a soldered connection. When a piece of music stored on a compact disc (CD) is being played back, the signal source device generates a transmission signal representing the piece of music and transmits it over the cable to the headphones.

There is a problem with the known signal transmission system in that the transmission means formed by the cable and its mechanical couplings to the signal source device and the signal sink device are a considerable hindrance to the freedom of movement of a user because, if the user moves his head or if there are accelerative forces that act on the cable, the cable may exert a tractive force on the headphones that is transmitted via the headphones to an ear of the user and may therefore annoy or even physically irritate the user. There is also the problem that violent movements of the headphones may cause them to come out of contact with one or both of a user's ears or may even result in damage to the cable or to the coupling between the cable and the signal source device or signal sink device. Because the cable is mechanically coupled to the signal source device and the signal sink device, i.e. the headphones, there is also a problem when using the signal transmission system in that manipulating the cable or accommodating it in such a way that it is protected is generally a very complicated business and takes a considerable amount of time, which detracts from the pleasure the user takes in using the signal transmission system.

It is an object of the invention to overcome the problems detailed above in a signal transmission system of the kind specified in the first paragraph above and in a signal transmission method of the kind specified in the third paragraph above and to provide an improved signal transmission system and an improved signal transmission method, also to provide a new garment of the kind specified in the second paragraph above.

To allow the above object to be achieved, provision is made in a signal transmission system according to the invention of the kind specified in the first paragraph above for the signal source device to be arranged to emit an optical signal that represents the transmission signal generated, for the signal sink device to be arranged to receive the optical signal emittable by the signal source device, and for the transmission means to be formed by light-guiding means that are able to be coupled optically to the signal source device and the signal sink device and that are arranged to transmit the optical signal.

To allow the above object to be achieved, provision is made in garment according to the invention of the kind specified in the second paragraph above for the garment to have light-guiding means that are able to be coupled optically to a signal source device and a signal sink device and that are arranged to transmit an optical signal representing a transmission signal generated by the signal source device.

To allow the above object to be achieved, provision is made in a signal transmission method according to the invention of the kind specified in the third paragraph above for use to be made of an optical signal representing the transmission signal, which optical signal is transmitted by light-guiding means forming the transmission means, which light-guiding means are coupled optically to the signal source device and the signal sink device, wherein the optical signal is emitted from the signal source device to the light-guiding means and wherein the optical signal is emitted from the light-guiding means to the signal sink device and is received by the signal sink device.

What is achieved by the making of the provisions according to the invention is that the signal transmission system is made considerably easier to handle because it is possible to manage without any mechanical coupling of the transmission means to the signal source device or the signal sink device. The advantage is also obtained that a saving in weight is achieved by dispensing with any mechanical means for coupling the transmission means to the signal source device and the signal sink device. A further advantage that is obtained is that mechanical forces that act on the light-guiding means are not transmitted from the light-guiding means to the signal source device or the signal sink device. Another advantage that is obtained is that the signal transmission is not subject to disruptive electromagnetic influences that may act on the transmission means from outside the signal transmission system, thus enabling the signal transmission system to be inexpensively produced because it is then possible to dispense with any complex transmission protocol that would suppress or rule out any such influences, or with suitable and generally expensive screening measures against influences of this kind. Yet another advantage that is obtained is that less energy is required for the optical transmission of signals, which may have an advantageous effect on the maximum working endurance of the signal transmission system when the latter is powered by a chargeable or non-rechargeable battery.

In one solution according to the invention, it has proved advantageous if, of the signal source device and the signal sink device, at least one of the two said devices is arranged at a distance from the light-guiding means and is coupled to the light-guiding means via an air-gap. This gives the advantage that unrestricted freedom of movement is made possible for the user of the signal transmission system by the variable distance, depending on the particular movement, between the signal source device and/or the signal sink device and the light-guiding means, while at the same time there is a guarantee of safe and reliable operation by the signal transmission system regardless of the movements that may be made by the user.

In one solution according to the invention, it has also proved advantageous if the light-guiding means are in multi-fiber form. This provides the advantage of giving the light-guiding means a flexibility in practice that is adapted to any movement the user is able to make. What is also afforded by the fact of there being a plurality of paths for the guidance of light is signal transmission that is secure against partial destruction of individual fibers in the light-guiding means.

In one solution according to the invention, provision may be made for the light-guiding means to be fastenable directly to a user's body. What has proved particularly advantageous however is if, of the signal source device and the signal sink device, at least one of the two said devices is arranged for fastening to a garment and if the light-guiding means are arranged for fastening to a garment. This gives the advantage that the light-guiding means can be mounted on an outer side or inner side of a garment and, when required, can also be transferred easily and without any problems from one garment to another.

In one solution according to the invention, it has also proved advantageous if the light-guiding means have fastening means for fastening to a garment. This gives the advantage that the light-guiding means can be fastened to a garment irrespective of the particular nature of the garment and will be securely held thereon.

In one solution according to the invention, it has also proved advantageous if, of the signal source device and the signal sink device, at least one of the two said devices is arranged for fastening to a garment and if the light-guiding means form part of a garment. This gives the advantage that the light-guiding means, as such, do not appear to the user of the system to form transmission means belonging to the signal transmission system that require additional manipulation, and that all the user need be concerned with is positioning the signal source device in or on the garment in a suitable way, that is to say in a way appropriate to the optical coupling.

In one solution according to the invention, it has further proved advantageous if the light-guiding means have at least one light exit region arranged for optical coupling to the signal sink device, which region is arranged to emit the optical signal and is of light-scattering design and by means of it is possible for the optical signal emerging from the light-guiding means to be scattered into an area of space directed towards the signal sink device. This gives the advantage that reliable optical coupling is ensured for the transmission of signals between the light-guiding means and the signal sink device without a user having to do anything more and above all without the need for any complicated and time-consuming lining-up and/or adjustment of the light-guiding means.

In one solution according to the invention, it has further proved advantageous if the light-guiding means are arranged to be planar in form in their light exit region. This gives the advantage that signal transmission can be performed and relied on even if the light exit region is partly covered.

In one solution according to the invention, it has further proved advantageous if the light-guiding means have at least one light entry region arranged for optical coupling to the signal source device, which region is arranged to receive the optical signal and to be of light-collecting design and by means of it is possible for the optical signal entering the light entry region to be collected into the light-guiding means. This gives the advantage that reliable optical coupling is ensured for the transmission of signals between the signal source device and the light-guiding means without a user having to do anything further and above all without the need for any complicated and time-consuming lining-up and/or adjustment of the light-guiding means.

In one solution according to the invention, it has further proved advantageous if the light-guiding means are arranged to be planar in form in their light entry region. This gives the advantage that signal transmission can be performed and relied on even if the light entry region is partly covered.

These and other aspects of the invention are apparent from and will be elucidated with reference to the embodiments described hereinafter, to which however the invention is not limited.

### IN THE DRAWINGS

FIG. 1 is a diagrammatic view of a signal transmission system forming a first embodiment of the invention.

FIG. 2 is a view that shows, in a similar way to FIG. 1, part of light-guiding means of a signal transmission system forming a second embodiment of the invention.

FIG. 3 is a section on line III-III of FIG. 2, to a larger scale than FIG. 2, showing the light-guiding means of the signal transmission system forming the second embodiment of the invention.

FIG. 4 is a diagrammatic view of the first embodiment of signal transmission system according to the invention, when worn by a user and with part of the system fastened to a garment.

FIG. 5 is a view similar to FIG. 4 showing the second embodiment of signal transmission system according to the invention when worn by a user.

FIG. 6 is a diagrammatic view of a signal transmission system forming a third embodiment of the invention when worn by a user.

FIG. 7 is a diagrammatic view showing a belt for fastening in place a signal source device of the third embodiment of signal transmission system according to the invention, which belt has light-guiding means.

FIG. 8 is a diagrammatic view showing a detail of the fastening belt of FIG. 7.

FIG. 9 is a diagrammatic view showing a sports garment for the third embodiment of signal transmission system according to the invention, which garment has light-guiding means.

FIG. 10 is a view similar to FIG. 9 showing a sports garment for a fourth embodiment of signal transmission system according to the invention, which garment has light-guiding means.

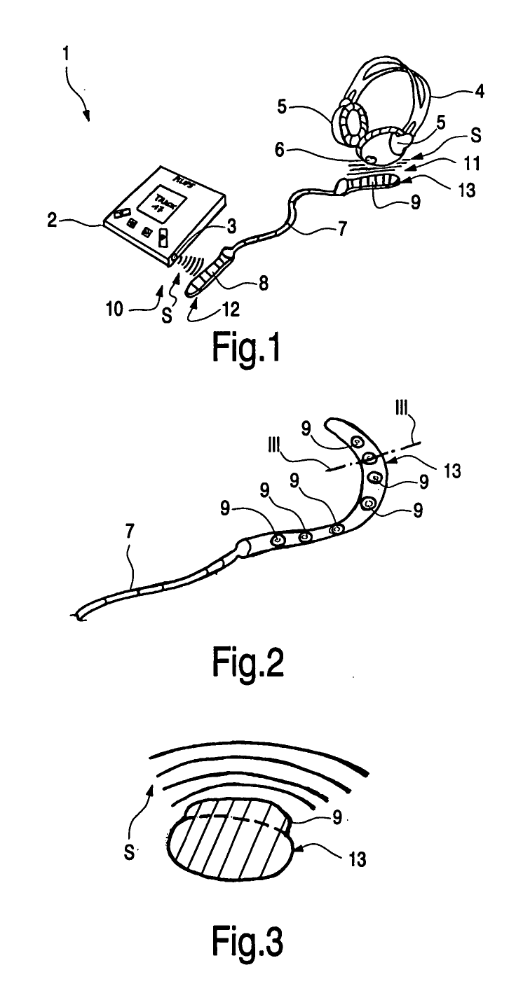

Shown in FIG. 1 is a signal transmission system 1 that is formed by a mobile audio reproducing or playing system that can be worn by a user. The signal transmission system 1 has a signal source device 2 that is arranged to generate a transmission signal. The signal source device 2 is formed by a portable audio player unit that is designed to reproduce a piece of music stored in a standardized MP3 data format, the transmission signal representing the piece of music that is reproduced. The signal source device 2 is further arranged to emit an optical signal S, which optical signal S represents the transmission signal generated. For this purpose, the signal source device 2 has optical transmitting means 3 that are arranged to receive the transmission signal, to generate the optical signal S from the transmission signal, and to emit the optical signal S.

The signal transmission system 1 also has a signal sink device 4 that is arranged to process the transmission signal. The signal sink device 4 is formed by a set of headphones that can be worn by the user of the signal transmission system 1 on his head and that have a pair of acoustic-signal emitting means that are arranged to cover the user's ears and that are further arranged to generate an acoustic signal from the transmission signal and to emit the acoustic signal generated into the user's ears. The signal sink device 4 is also arranged to receive the optical signal S able to be emitted by the signal source device 2. For this purpose, the signal sink device 4 has optical receiving means 6 by means of which the optical signal S can be received and converted into the transmission signal able to be processed by the signal sink device 4.

The signal transmission system 1 also has transmission means that are provided between the signal source device 2 and the signal sink device 4 and that can be coupled to the signal source device 2 and the signal sink device 4, the transmission means being formed by light-guiding means 7 that can be coupled to the signal source device 2 and the signal sink device 4 optically and that are arranged to transmit the optical signal S. In the present case the light-guiding means 7 are formed by an optical fiber.

The light-guiding means 7 have a light entry region 8 arranged for optical coupling to the signal source device 2, which region 8 is arranged to receive the optical signal S and is of a light-collecting form and by means of it it is possible for the optical signal S entering the light entry region 8 to be collected into the light-guiding means 7. The light entry region 8 is planar in form and, where coupling is optical, is directed towards the optical transmitting means 3 of the signal source device 2.

The light-guiding means 7 also have a light exit region 9 arranged for optical coupling to the signal sink device 4, which region 9 is arranged to emit the optical signal S and is of a light-scattering form and by means of it it is possible for the optical signal S emerging from the light-guiding means 7 to be scattered into a region of space directed towards the signal sink device 4. In their light exit region 9 the light-guiding means 7 are planar in form and, for the purpose of optical coupling to the signal sink device 4, are directed towards the optical receiving means 6.

The signal source device 2 and light-guiding means 7 are arranged at a distance from one another and are coupled together via a first air-gap 10. The light-guiding means 7 and the signal sink device 4 are arranged at a distance from one another and are coupled together via a second air-gap 11. It is useful in this case for the distance between the optical transmitting means 3 and the light entry region 8 to be small in comparison with the distance between the optical receiving means 6 and the light exit region 9, the two distances being dependent on the size of the body of the user of the signal transmission system 1 and on the way in which the signal transmission system 1 is used or held or worn by the user. In the case of the light-guiding means 7, the light entry region 8 is arranged in a first end-region 12 of the light-guiding means 7 and the light exit region 9 is arranged in a second end-region 13 of the light-guiding means 7, the two end-regions 12 and 13 being of a straight configuration. It should be mentioned that the two regions 12 and 13 could also be of a spiral configuration, which would allow coupling to take place substantially irrespective of orientation.

In the light-guiding means 7 shown in FIG. 2, the end-region 13 of the light-guiding means is of a curved shape, thus assisting with the wearing of the light-guiding means 7 in a head-and-neck region of the user of the signal transmission system 1. The light-guiding means 7 also have a plurality of light exit regions 9 within the second end-region 13 of the light-guiding means. The second end-region 13 of the light-guiding means 7 is also wider in cross-section than its other regions. It should be mentioned at this point that the light-guiding means 7 may also be of uniform cross-section throughout their entire length and that the light entry region 8 too may be configured in a similar way to the light exit region 9 shown in FIG. 2.

The shape of the cross-sectional face of the second end-region 13 of the light-guiding means 7 in the region of a section taken on line III-III in FIG. 2 can be seen in FIG. 3. In this end-region 13, the light-guiding means 7 have a light exit region 9 that projects in the form of a knob from the end-region 13, which later is in the form of a substantially oval (or even circular) disc, which assists the optical signal S in emerging from the light exit region 9 in a substantially conical shape.

It should be mentioned that the light entry region 8 and the light exit region 9 may also be formed by a plurality of funnel-shaped formations in the light-guiding means 7. It should also be mentioned that the regions 8 and 9 need not be arranged solely in the direction of the lengthwise extension of the light-guiding means 7 but could also be arranged or distributed in the circumferential direction of the light-guiding means 7, thus ensuring that there is sufficiently good coupling for the transmission of signals even when the cross-section is circular.

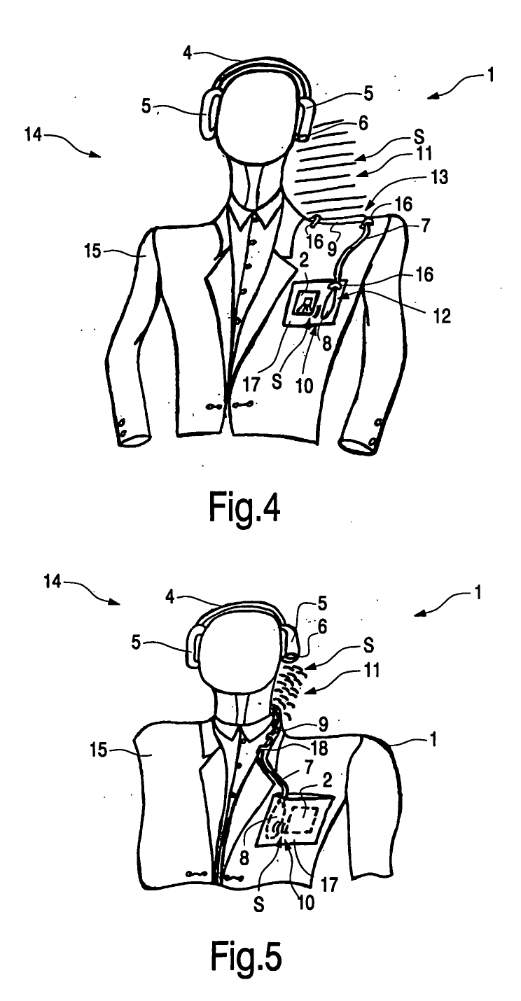

In FIG. 4 are shown the head, neck and chest of a user 14 who is wearing the signal transmission system 1. The user 14 wears the signal sink device 4 on his head. On his chest the user 14 wears a garment 15 for the signal transmission system 1, which garment 15 has the light-guiding means 7 that can be coupled to the signal source device 2 and the signal sink device 4 optically and that are arranged to transmit the optical signal S, which optical signal S represents a transmission signal generated by the signal source device 2. The garment 15 has three fastening strips 16 that are designed to fasten the light-guiding means 7 to the garment 15. The fastening strips 16 are arranged in the region of a shoulder part of the garment 15 and in the region of a breast pocket 17 of the garment 15. The fastening strips 16 are also so designed that they can be repeatedly detached from the garment 15 and connected to the garment 15, thus making the light-guiding means 7 removable from and connectable to the garment 15. For this purpose the fastening strips 16 have parts of Velcro-type fasteners. It should be mentioned that the fastening strips 16 may also have adhesive fasteners to cooperate with the garment 15 or buttons or press-studs. What is more, the fastening strips 16 may also have adhesive areas for bonding the light-guiding means 7 solidly to the fastening strips 16. It should further be mentioned that the fastening strips 16 may also be provided on an inner side of the garment 15 adjacent the user 14. Further, it should be mentioned that in place of the fastening strips 16 cavities may be provided in the garment 15, into which cavities the light-guiding means 7 may be inserted or through which cavities the light-guiding means 7 may be run.

With regard to their configuration and dimensions and flexibility or, in more general terms, with regard to their geometrical dimensions and mechanical properties, the light-guiding means 7 are designed for fastening to the garment 15, in which case they cooperate with the fastening strips 16 in such a way that at least the light entry region 8 and the light exit region 9 can be held in a position and orientation suitable for the transmission of signals.

The signal source device 2 is further designed for fastening to the garment 15, in which case the fastening to the garment 15 ensures that the position and orientation of the signal source device 2 are suitable for the transmission of signals.

In what follows, the operation of the signal transmission system 1 will now be described by reference to a first embodiment of the signal transmission system 1. In this embodiment it is assumed that the piece of music to be played or reproduced is Mozart's singspiel “Bastien und Bastienne”. It is also assumed that the signal transmission system 1 is being worn by a user 14 in the way shown in FIG. 4.

The user 14 first starts the reproduction of the piece of music, whereupon a signal transmission method according to the invention is executed by means of the signal transmission system 1 to transmit the transmission signal from the signal source device 2 to the signal sink device 4, the transmission signal being generated by means of the signal source device 2 and being processed by means of the signal sink device 4. The method has the steps specified below, namely: transmission of a signal representing the transmission signal from the signal source device 2 to the signal sink device 4 by means of the transmission means that are provided between the signal source device 2 and the signal sink device 4 and that are coupled to the signal source device 2 and the signal sink device 4 for the transmission of signals, an optical signal S representing the transmission signal being used, which signal S is transmitted by light-guiding means 7 that form the transmission means and are coupled optically to the signal source device 2 and the signal sink device 4, and the optical signal S being emitted from the signal source device 2 to the light-guiding means 7, and the optical signal S being emitted from the light-guiding means 7 to the signal sink device 4 and being received by the signal sink device 4.

In this case, the transmission signal, in the form of an electrical signal, is first generated by the signal source device 2 within the signal source device 2 and is converted into the optical signal S by the optical transmitting means 3. By means of the optical transmitting means 3, the optical signal S is transmitted via the first air-gap 10 from the signal source device 2 to the light-guiding means 7, which light-guiding means 7 the optical signal S enters via the light entry region 8 of planar form and is guided through the light-guiding means 7. The optical signal S subsequently emerges from the light-guiding means 7 via the light exit region 9 of planar form and is transmitted from the light-guiding means 7 via the second air-gap 11 to the signal sink device 4. The optical signal S is received by the optical receiving means 6 and converted into the transmission signal and processed by the signal sink device 4 in such a way that an acoustic signal is emitted into the ears of the user 14.

The making of the provisions according to the invention gives the advantage that the freedom of movement of a user of the signal transmission system 1 is not interfered with by the signal transmission system 1. A further advantage that is obtained is that the parts of the signal transmission system 1 can be dealt with separately from one another, thus ensuring that the signal transmission system 1 is not difficult to handle. A further advantage that is obtained is that the transmission of the transmission signal, which is performed optically, is not prone to interference caused by radio signals acting on the signal transmission system 1 from outside.

In the signal transmission system 1 shown in FIG. 5, which is being worn by the user 14, the light-guiding means 7 are designed to be fastened to the garment 15 and for this purpose have fastening means 18 that in the present case are formed by a plurality of hook-like projections from the light-guiding means 7, thus enabling the light-guiding means 7 to be fastened in place in a curved form along the collar region of the garment 15 to hug the user's neck region, at least in areas. It should be mentioned at this point that the fastening means 18 of the light-guiding means 7 may also be formed by using any of the facilities listed in connection with the fastening strips 16 on the garment 15 shown in FIG. 4.

Starting from the collar region of the garment 15, the light-guiding means 7 shown in FIG. 5 extend in the direction of the breast pocket 17, the light entry region 8 being positioned in the breast-pocket. The signal source device 2 is arranged inside the breast pocket 17 adjacent to the light entry region 8.

In what follows, the operation of the signal transmission system 1 will now be described by reference to a second embodiment of the signal transmission system 1.

In contrast to the first embodiment, it is assumed in this case that the signal transmission system 1 is being worn by a user 14 in the way shown in FIG. 5. In this embodiment, the optical signal S transmitted by means of the light-guiding means 7 is emitted from the light-guiding means 7 to the signal sink device 4 via the plurality of light exit regions 9. The making of the provisions according to the invention gives the advantage that the transmission of signals can be performed reliably even if the user 14 has long, flowing hair.

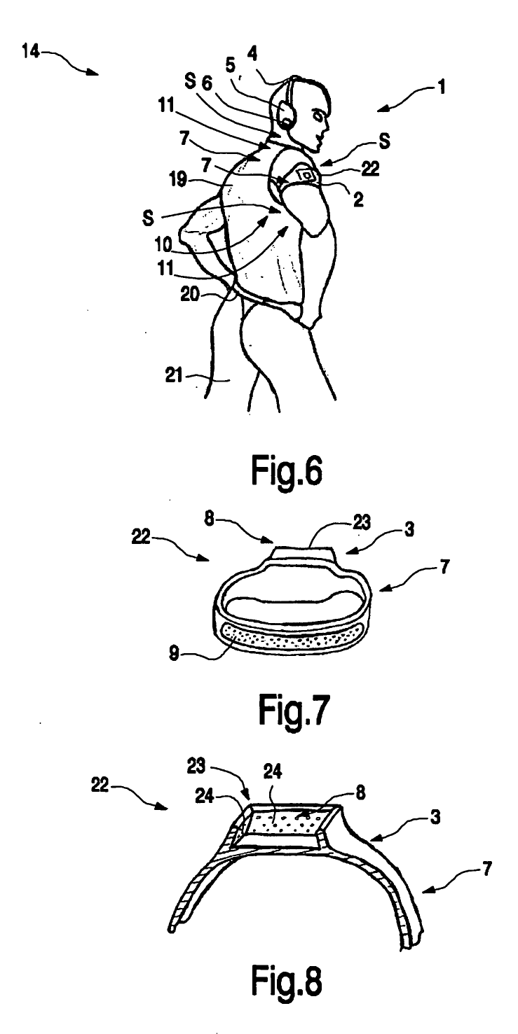

Shown in FIG. 6 is a user 14 representing an athlete. The athlete is wearing a sport tank top 19 as a garment 15, a belt 20, sport pants 21 and an armband 22. The user 14 is also wearing the signal transmission system 1, the light-guiding means 7 being in multi-part form in this case. In the present case, the light-guiding means 7 extend beyond the garment, being formed by parts of the sport tank top 19 and parts of the armband 22, which form of production will be considered in detail in the paragraphs below.

The armband 22, which is shown in detail in FIG. 7 and FIG. 8, is designed for fastening the signal source device 2 to the user's arm and for this purpose it has signal-source fastening means 23 that are of a shape and design matched to the shape of the signal source device 2 to allow the signal source device 2 to be received and fastened in place. The armband 22 is further designed for transmitting the optical signal S from the signal source device 2 to the tank top 19.

The signal-source fastening means 23 have, on their inner faces 24 directed towards the signal source device 2, the first end-region 12 of the light-guiding means, in which region are provided light entry regions 8 that are of point form and are equidistantly distributed over all the inner faces 24. In a position remote from the signal-source fastening means 23, the armband 22 also has the second end-region 13 of the light-guiding means, in which region are provided equidistantly distributed light exit regions 9 in point form. The light-guiding means 7 incorporated in the armband 22 are of multi-fiber form and extend from the light entry regions 8 to the light exit regions 9.

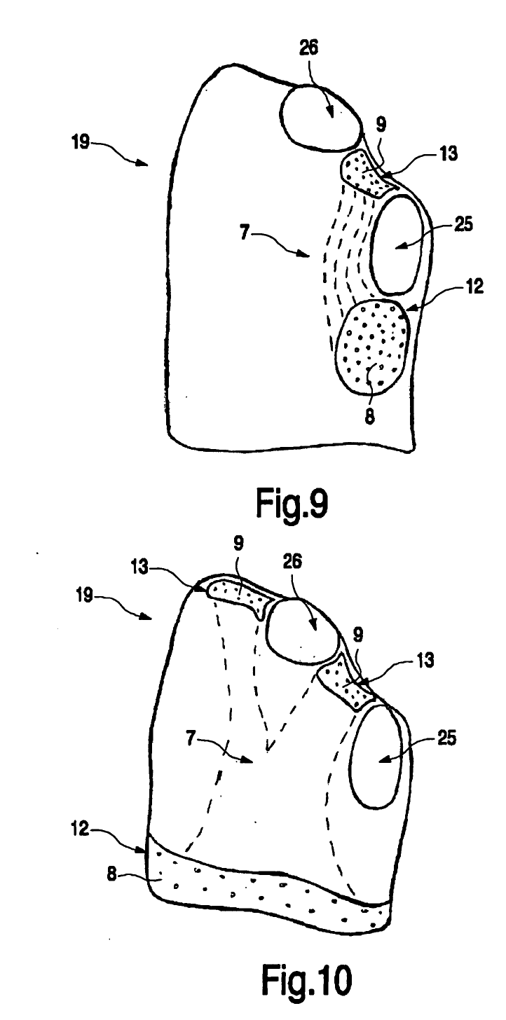

The sport tank top 19 shown in FIG. 9 is designed to transmit the optical signal S emittable by the signal source device 2 to the signal sink device 4, the sport tank top 19 being designed for optical coupling to the armband 22 and the signal sink device 4. For this purpose, the tank top 19 has the light-guiding means 7, which are incorporated in its filamentary texture and which are advantageously of multi-fiber form. It should be mentioned at this point that that the light-guiding means 7 may even form part of the fabric of the garment, i.e. may be woven into its filamentary texture.

The sport tank top 19 also has, below an arm opening 25, the first end-region 12 of the light-guiding means 7. The tank top 19 further has the second end-region 13 of the light-guiding means 7, which is arranged between the region of the arm opening 25 and the region of the head opening 26. In the present case the first end-region 12 of the light-guiding means 7 has a plurality of light entry regions 8 and the second end-region 13 of the light-guiding means 7 has a plurality of light exit regions 9 of point form. It should however be mentioned that the regions 8 and 9 could also each be formed by continuous surfaces.

What is advantageously achieved by the design according to the invention of the armband 22 and the sport tank top 19 is that the light-guiding means 7 can be used for the optical transmission of signals in the signal transmission system 1 even across a plurality of garments, even though they may not appear to be such to a user.

The sport tank top 19 shown in FIG. 10 has, within the first end-region 12 of the light-guiding means 7, a plurality of light entry regions 8 that are arranged along a hip area of a user 14. This gives the advantage that hip-hugging optical coupling is possible to sport pants or to a sports belt or direct to a signal source device 2.

The sport tank top 19 also has, in both the left and right-hand shoulder portions, light exit regions 9 that are connected to the light inlet-regions 8 of the light-guiding means 7, thus ensuring that there is reliable optical coupling between the light-guiding means 7 and the signal sink device 4 irrespective of the orientation produced by the way in which the signal sink device 4 is worn on the user's head.

It should be mentioned that the light exit region 9 is arranged for the emergence of at least part of the optical signal S arising in the light-guiding means 7 in a direction that is oblique relative to the direction of propagation of the optical signal S in the light-guiding means 7.

It should be mentioned that the transmission means may also be formed by light-guiding means 7 that are produced in more than one part, which means allow signals to be transmitted across more than one garment. However, explicit mention should be made in this connection of the fact that the making of the provisions according to the invention does not limit coupling between garments to the garments that are disclosed here but that it can be performed generally between any desired garments. In this way, a signal source device may even be provided in, for example, a shoe, in which case this signal source device 2 may be designed for coupling to light-guiding means 7 situated in the shoe or for coupling to light-guiding means 7 situated in pants.

It should be mentioned that a signal transmission system 1 may also have a mobile telephone that is fitted with a hands-free facility, in which case the signal source device 2 may take the form of a microphone that is part of the hands-free facility and is worn on, for example, the head of a user, and the signal sink device 4 may be formed by the mobile telephone, which is accommodated in, for example, a breast pocket of a garment, thus enabling a transmission signal generated by means of the microphone to be transmitted optically via the light-guiding means 7 to the mobile telephone.

It should be mentioned that the signal transmission system 1 may also take the form of a recording system, which recording system has a microphone as its signal source 2 and a recording device as its signal sink 4.

It should be mentioned that the light entry region 8 and the light exit region 9 need not be provided only at the end-regions 12 and 13 of the light-guiding means 7 but may be provided in intermediate regions along the light-guiding means 7, which intermediate regions are located between the end-regions 12 and 13.

It should also be mentioned that it is also possible for a plurality of mutually independent light entry regions 8 to be provided to enable optical coupling to take place to a plurality of signal source devices 2. The same is true, mutatis mutandis, of the light exit region 9 and the signal sink device 4. In this way, a further signal source device may for example be formed by a remote control that in turn is designed to generate and emit an optical signal, which optical signal represents control data for an audio reproducing device and/or a set of headphones that can be coupled optically to the light-guiding means 7. The remote control may be entirely separate from the audio reproducing device or the headphones in this case and may be provided on the user's body or at any desired point in or on his clothing, provided there is a light entry region 8 provided in the surroundings thereof. In the case of a signal transmission system of this kind, the audio reproducing device, as well as having the optical transmitting means 3, also has optical receiving means that are arranged to receive the optical signal transmitted from the remote control via the light-guiding means 7. It should also be mentioned in this connection that the remote control may also be provided in the headphones, in which case the headphones will have, as well as their optical receiving means 6, optical transmitting means too.

It should also be mentioned that the light entry region 8 and the light exit region 9 may be ribbed or undulating in configuration.

It should further be mentioned that the transmission signal may also represent a video signal or a combined video/audio signal or a data signal.

1. A signal transmission system (1) having a signal source device (2) that is arranged to generate a transmission signal, having a signal sink device (4) that is arranged to process the transmission signal, and having transmission means that are provided between the signal source device (2) and the signal sink device (4), that can be coupled to the signal source device (2) and the signal sink device (4) for the transmission of signals, and that are arranged to transmit a signal representing the transmission signal from the signal source device (2) to the signal sink device (4), characterized in that the signal source device (2) is arranged to emit an optical signal (S) that represents the transmission signal generated, in that the signal sink device (4) is arranged to receive the optical signal (S) emittable by the signal source device (2), and in that the transmission means are formed by light-guiding means (7) that are able to be coupled optically to the signal source device (2) and the signal sink device (4) and that are arranged to transmit the optical signal (S).

2. A signal transmission system (1) as claimed in claim 1, characterized in that, of the signal source device (2) and the signal sink device (4), at least one of the two said devices is arranged at a distance from the light-guiding means (7) and is coupled to the light-guiding means (7) via an air-gap (10, 11).

3. A signal transmission system (1) as claimed in claim 1, characterized in that the light-guiding means (7) are of a multi-fiber form.

4. A signal transmission system (1) as claimed in claim 1, characterized in that, of the signal source device (2) and the signal sink device (4), at least one of the two said devices is arranged for fastening to a garment (15) and in that the light-guiding means (7) are arranged for fastening to a garment (15).

5. A signal transmission system (1) as claimed in claim 4, characterized in that the light-guiding means (7) have fastening means (18) for fastening to a garment (15).

6. A signal transmission system (1) as claimed in claim 1, characterized in that, of the signal source device (2) and the signal sink device (4), at least one of the two said devices is arranged for fastening to a garment (15), and in that the light-guiding means (7) form part of a garment (15).

7. A signal transmission system (1) as claimed in claim 1, characterized in that the light-guiding means (7) have at least one light exit region (9) arranged for optical coupling to the signal sink device (4), which region (9) is arranged to emit the optical signal (S) and is of light-scattering design and by means of which it is possible for the optical signal (S) emerging from the light-guiding means (7) to be scattered into an area of space directed towards the signal sink device (4).

8. A signal transmission system (1) as claimed in claim 7, characterized in that the light-guiding means (7) are arranged to be planar in form in their light exit region (9).

9. A signal transmission system (1) as claimed in claim 1, characterized in that the light-guiding means (7) have at least one light entry region (8) arranged for optical coupling to the signal source device (2), which region (8) is arranged to receive the optical signal (S) and has a light-collecting design, and by means of which it is possible for the optical signal (S) entering the light entry region (8) to be collected into the light-guiding means (7).

10. A signal transmission system (1) as claimed in claim 9, characterized in that the light-guiding means (7) are arranged to be planar in form in their light entry region (8).

11. A garment (15) for a signal transmission system (1), characterized in that the garment (15) has light-guiding means (7) that are able to be coupled optically to a signal source device (2) and a signal sink device (4) and that are arranged to transmit an optical signal (S) representing a transmission signal generated by the signal source device (2).

12. A signal transmission method for transmitting a transmission signal from a signal source device (2) to a signal sink device (4), wherein the transmission signal is generated by means of the signal source device (2) and processed by means of the signal sink device (4), which method has the steps specified below, namely, transmission of a signal representing the transmission signal from the signal source device (2) to the signal sink device (4) by means of transmission means that are provided between the signal source device (2) and the signal sink device (4) and that are coupled to the signal source device (2) and the signal sink device (4) for the transmission of signals, characterized in that use is made of an optical signal (S) representing the transmission signal, which optical signal (S) is transmitted by light-guiding means (7) forming the transmission means, which light-guiding means (7) are coupled optically to the signal source device (2) and the signal sink device (4), wherein the optical signal (S) is emitted from the signal source device (2) to the light-guiding means (7) and wherein the optical signal (S) is emitted from the light-guiding means (7) to the signal sink device (4) and is received by the signal sink device (4).

13. A signal transmission method as claimed in claim 12, characterized in that the optical system (S) is transmitted from the signal source device (2) to the light-guiding means (7) via a first air-gap (10).

14. A signal transmission method as claimed in claim 12, characterized in that the optical signal (S) is transmitted from the light-guiding means (7) to the signal sink device (4) via a second air-gap (11).
